(19) United States
(12) Patent Application Publication
(10) Pub. No.: US 2007/0070626 A1
(43) Pub. Date: Mar. 29, 2007

(54) Lighting substrate

(76) Inventor: Kevin Raymond Deguara, St. Albans (AU)

Correspondence Address: ANTOINETTE M. TEASE, P. O. BOX 51016, BILLINGS, MT, 59105, US

(21) Appl. No.: 10/554,984

(22) PCT Filed: Apr. 30, 2004
(86) PCT No.: PCT/AU04/00561

§ 371 Date: Jan. 5, 2006

(30) Foreign Application Priority Data
May 1, 2003 (AU) 200390202073

(51) Int. Cl. F21V 21/00

(52) U.S. Cl. 362/249

(57) ABSTRACT

A lighting substrate (10) for supporting an array of interconnected lights (12) at space intervals includes an array of holes (11) and holding means (17, 22, 23, 44) arranged at least at some of the holes, wherein the interconnected lights (12) are each securely but removeably held in the holding means to shine light through the holes.

The present invention concerns a lighting substrate that supports an array of lights, and in particular small decorative lights. The invention also concerns a lighting arrangement incorporating the lighting substrate together with an array of lights.

### BACKGROUND

Modern day low voltage LED's (Light Emitting Diodes) and bud lights are popularly used as decorative lighting for parties, festive celebrations or simply for general decoration. These small and efficient lights can be found in imaginative interconnected arrays of two and three-dimensional shapes. These also usually feature a selection of lighting sequences of varying colour combinations and blinking rates.

Decorative lights of these kind are generally only available in pre-defined arrays and patterns and do not cater for personal customisation.

### SUMMARY

In one aspect the present invention provides a lighting substrate for supporting an array of interconnected lights at space intervals, the substrate including an array of holes and holding means arranged at least at some of the holes, wherein the interconnected lights are each securely but removeably held in the holding means to shine light through the holes.

The lighting substrate in one embodiment is made of a resilient material, typically polypropylene. In this embodiment, the inherent resilience of the substrate acts as the holding means such that when a light is inserted through a hole the resilient force of the substrate on the light holds the light in position.

In a preferred embodiment of the resilient substrate, slits provided at the edges of the holes ease insertion and removal of lights. The holes are preferably sized to receive small decorative lights.

Alternatively, the holding means may be a clip moulded at or attached to each hole and designed to clip a light into position. The clip may include side arms projecting from the substrate to confine a light therebetween.

The substrate may be a solid frame or a flexible fabric such as a woven net and can come in the form of a two-dimensional panel or a three-dimensional surface.

The lighting substrate may optionally be encased in a housing to hide electrical wires at the rear of the substrate.

The invention also provides a method for creating a light display including: inserting an array of interconnected lights into an array of holes in a lighting substrate, the interconnected lights being removably held in holding means arranged at least at some of the holes and adapted to shine through the holes.

In another aspect the invention provides a lighting assembly comprising an array of interconnected lights, and a lighting substrate for supporting the interconnected lights at spaced intervals, the substrate including an array of holes and holding means arranged at least at some of the holes, wherein the interconnected lights are each securely but removeably held in the holding means to shine light through the holes.

The lights are preferably small LED light or bud lights.

### BRIEF DESCRIPTION OF THE DRAWINGS

The present invention is described further by way of example with reference to the accompanying drawings by which:

FIG. 1 is a front view of a lighting substrate matrix formed from three joined lighting substrates according to one embodiment the invention;

FIG. 2A is a part perspective view of a light being located in a lighting substrate according to an embodiment of the invention;

FIG. 2B is a side sectional view of the lighting substrate of FIG. 2A, with a light located in the substrate;

FIG. 3A is a part perspective view of a light being located in another embodiment of a lighting substrate;

FIG. 3B is a side sectional view of the light located in the lighting substrate of FIG. 3A at section A-A;

FIG. 4A is a perspective view of a light located in another embodiment of the lighting substrate;

FIG. 4B is a first side sectional view of FIG. 4A;

FIG. 4C is a second side sectional view of FIG. 4A;

FIG. 5A is a perspective view of a light being located in yet another embodiment of the lighting substrate;

FIG. 5B is a side sectional view of the light located in the lighting substrate of FIG. 5A;

FIG. 6A illustrates a first step in connecting a light to an embodiment of the lighting substrate;

FIG. 6B is a second step of the embodiment of FIG. 6A;

FIG. 6C is a third step of the embodiment of FIG. 6A;

FIG. 6D is a fourth step of the embodiment of FIG. 6A;

FIG. 7A is a perspective view of a light being located in yet another embodiment of the lighting substrate;

FIG. 7B is a perspective view of a light being located in yet another embodiment of the lighting substrate;

FIG. 7C is a side sectional view of a light located in the embodiment of FIG. 7B;

FIG. 7D is a perspective view of a light being located in yet another embodiment of the lighting substrate;

FIG. 8 is a part perspective view of two lighting substrate casings in accordance with an embodiment of the present invention located side by side;

FIG. 9 is a part perspective view illustrating engagement of two lighting substrate casings in accordance with another embodiment of the invention;

FIG. 10 is a front view of a lighting substrate matrix;

FIG. 11A is a perspective view of a panel with rear cover forming an embodiment of the present invention;

FIG. 11B is a part side sectional view of the joint panel and cover of the embodiment of FIG. 10;

FIG. 12 is a perspective view of another embodiment of a panel in accordance with the present invention;

FIG. 13A is schematic representation of a lighting substrate in accordance of the present invention;

FIG. 13B is a schematic representation of two lighting substrates join together in accordance of the present invention;

FIG. 13C is a schematic representation of four lighting substrates in accordance of the present invention join together to form a square;

FIG. 13D is a schematic representation of three lighting substrates in accordance of the present invention join together to form a linear form;

FIG. 14A is a part perspective view of an embodiment of a lighting substrate;

FIG. 14B is a side sectional view of the embodiment of FIG. 14A;

FIG. 15 illustrates examples of templates in accordance with the present invention; and

FIG. 16 is a flow chart illustrating steps in creating a template in accordance with the present invention.

### DETAILED DESCRIPTION OF PREFERRED EMBODIMENT

The lighting substrates illustrated in the drawings allow users to modify decorative lighting into endless configurations and shapes according to specific occasions, business needs and personal tastes. This is achieved by providing a substrate for supporting an array of lights but which allows the lights to be repeatedly removed and reinserted in altered configurations. By analogy the lighting substrate provides a blank canvas on which a user can create any desired design configuration of lights.

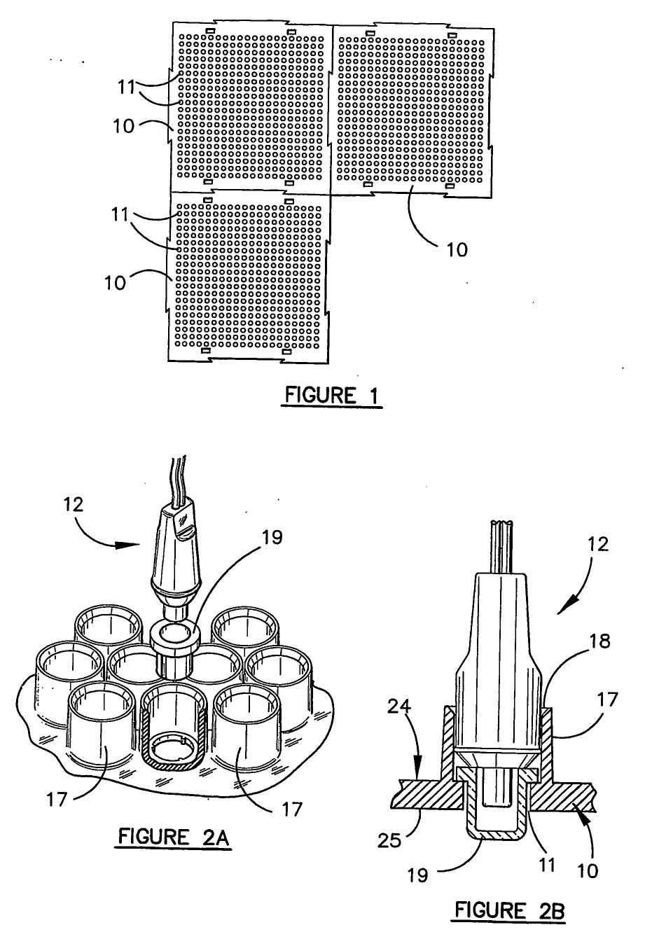

The lighting substrate is square in shape and forms a discrete modular unit for interconnection with other lighting substrates to create a larger lighting display. FIG. 1 illustrates three lighting substrates 10 interconnected to one another to form an “L” shape. The modular substrates create a larger surface for illuminating lights thereby allowing for a greater diversity of possible designs.

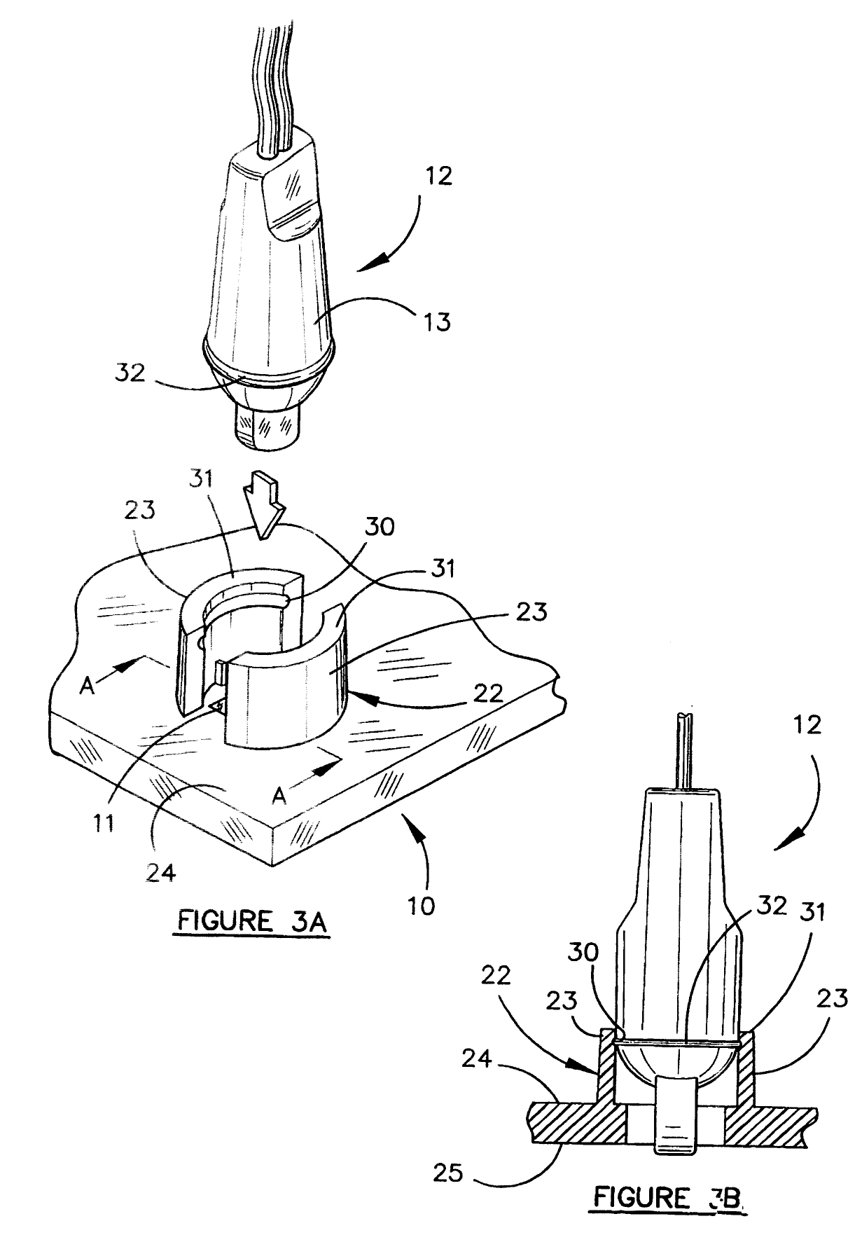

Each lighting substrate 10 has an array of holes 11 that are designed to each receive a light 12 (see FIGS. 2A and 2B, and other figures for lights 12). In most cases the lights 12 will be electrically interconnected in series or parallel to a control circuit (not shown). The control circuit is programmed to simply illuminate the lights or illuminate them in a range of sequences and effects. For example, the control circuit can be programmed to create blinking effects with the lights including running lights, blinking sequences and other flashing configurations.

The lights of choice in recent times are low voltage LED's or low voltage bud lights as these are more versatile in sequence lighting, they are small, bright, inexpensive and aesthetically decorative. LED's and bud lights may be obtained in a variety of colours. Additionally, bud lights in particular are also available as a white light that may be covered by a coloured translucent or transparent diffuser cap.

While several types of lights have been described herein, it is understood that any type of light could be just as effectively used with the present lighting substrate.

As illustrated in FIGS. 2A to 7D, holding means on the substrate 10 releaseably retain the lights 12 in place. The holding means may come in a variety of forms.

FIGS. 2A to 5B illustrate various designs of holding means in the form of clips 17, 22, 23, 44 that are either attached or moulded to a plastic lighting substrate 10.

In FIGS. 2A and 2B, clip 17 is a cylindrical moulding on the rear 24 of lighting substrate 10. Clip 17 exhibits some resilience which, together with an upper lip 18, holds light 12 firmly in hole 11 to shine through to the front 25 of substrate 10.

The light illustrated in these figures is a white bud light. A diffuser lens cap 19 is also located through hole 11 to filter the white light produced by light 12 into a colour. The lens cap can be specially made to clip into the clip 17 by way of a groove and ridge engagement. It is thereby held in position in hole 11 to diffuse light emanating from light 12 behind the cap.

The clip 22 of FIGS. 3A and 3B comprises two symmetrically facing arced projections 23 extending from the rear 24 of the substrate so as to not be seen from the front 25. The hole 11 is centrally located in between the arced projections. Light 12 is an LED or bud light that is inserted between the arced projections 23 and snaps into position. In this embodiment, light 12 is not associated with a diffuser cap. Instead, the bulb protrudes through the hole 11.

Snap connection of the light 12 into clip 22 occurs by way of a groove and ridge. Grooves 30 on the inside of each arced projection run parallel to the plane of the lighting substrate and are located near the outer rim 31 of the projections. The grooves 30 receive a corresponding ridge 32 on the light body 13 to snap fit the light in the clip 22.

If the lighting substrate is distributed without decorative lights, the grooves may need to be designed to be compatible with existing ridges or protrusions on lights already available on the market.

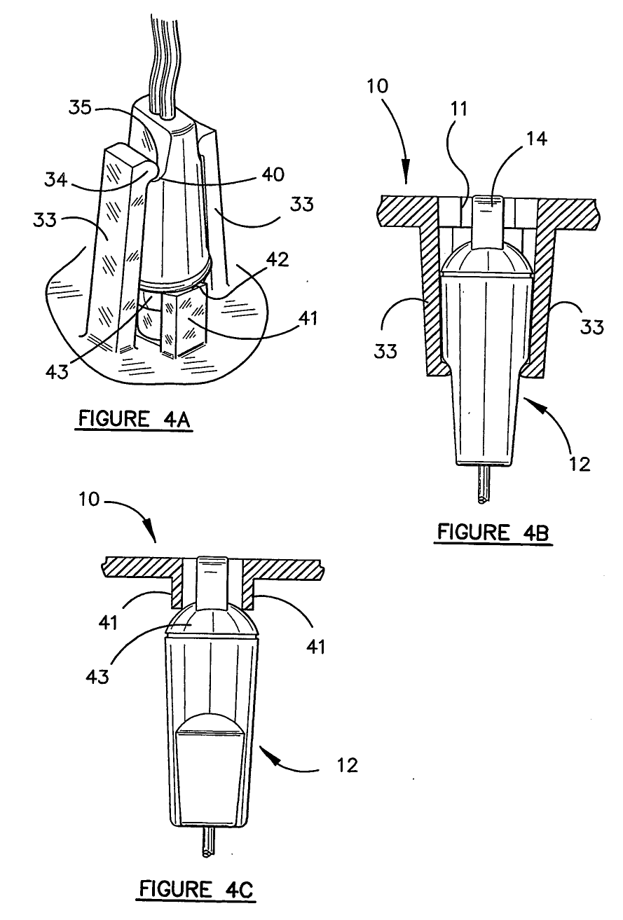

FIGS. 4A to 4C illustrate another form of clip. Two snap arms 33 extend outwardly from the rear of the substrate on opposing sides of every hole 11. The ends of the arms 33 have hooks 34 facing each other. The head 35 of each hook is inclined inwards.

As a light is inserted into the clip it slides over the head 35 pushing apart the arms. The arms hold an amount of elastic movement such that when the light clears the hooks 34, the arms move inwards and the hooks catch against shoulders 40 near the base of the light. Hence, the light is retained in the correct position.

In the embodiment of FIGS. 4A to 4C the light bulb is set back in the substrate so that the bulb does not protrude from the surface of the substrate but is flush with the surface. This gives the lighting substrate a different decorative look when illuminated.

Two stops 41 keep the light bulb set back from the substrate to achieve the flushed look. The stops also project outwardly from the rear of the substrate and are located opposing each other adjacent the snap arms 33. The stops 41 are significantly shorter than the snap arms since their ends 42 are intended to contact a rim or shoulder 43 on a light thereby preventing any further insertion of the light.

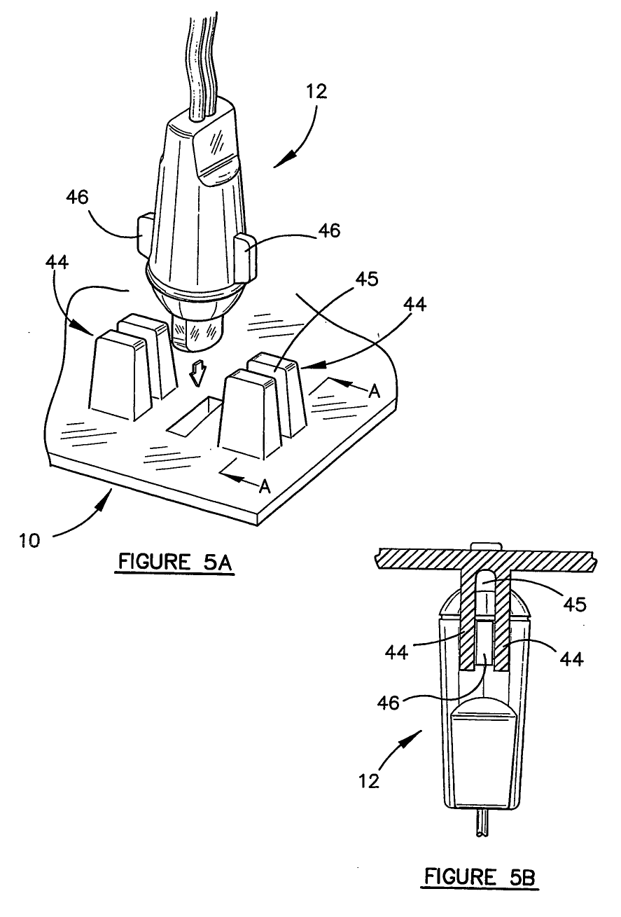

The embodiment of FIGS. 5A and 5B uses a set of two parallel ribs 44 on opposing sides of the hole 11 to hold the light 12 in place.

The parallel ribs 44 in each set are separated by a space 45. The parallel ribs are adapted to receive a light having fins 46 on opposing sides of the light body. The light is clipped into position by force fitting the fins 46 into the spaces 45.

The above described clips into which lights 12 are received are all moulded to the lighting substrate. In an alternative embodiment the clips may be formed separately from the lighting substrate and may snap fit in line with the holes 11 in the substrate 10. The advantage of this arrangement is that a number of clips can be manufactured that correspond equally with the number of lights, thereby avoiding an excess production of clips. This reduces manufacturing costs as well as clutter at the rear of the lighting substrate.

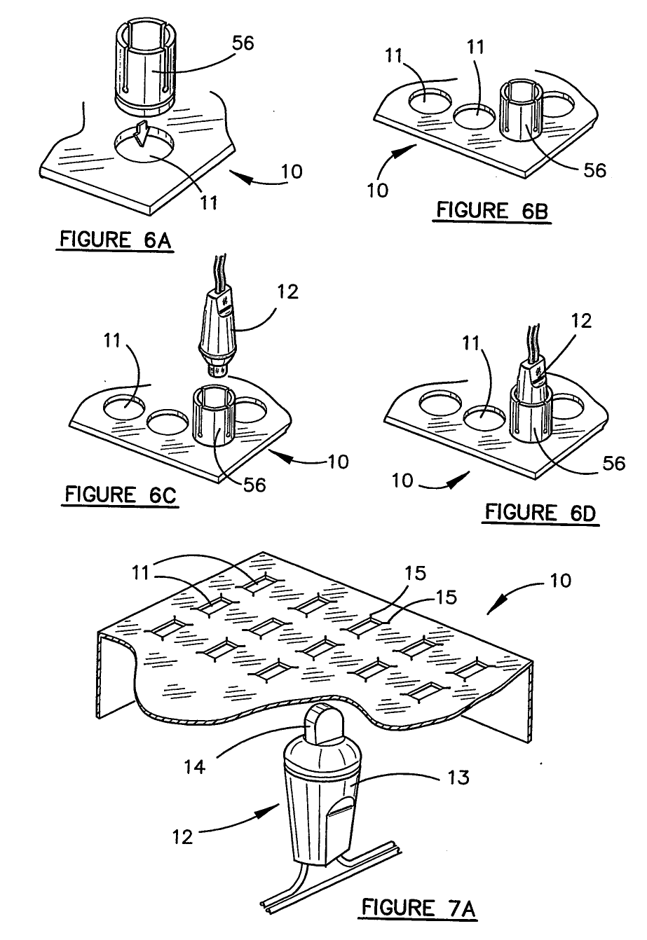

Such an arrangement is illustrated in FIGS. 6A to 6D which show in four steps the attachment of a clip 56 onto a lighting substrate 10 followed by attachment of the light 12. FIG. 6A illustrates cylindrical clip 56 snap fitting by way of a groove and ridge arrangement co-linearly with hole 11. FIG. 6B illustrates clip 56 located in one of the holes 11 in lighting substrate 10. FIG. 6C illustrates an LED light 12 being snap inserted into clip 56, and FIG. 6D illustrates light 12 firmly inserted in clip 56 and held therein by the resilient arms of clip 56.

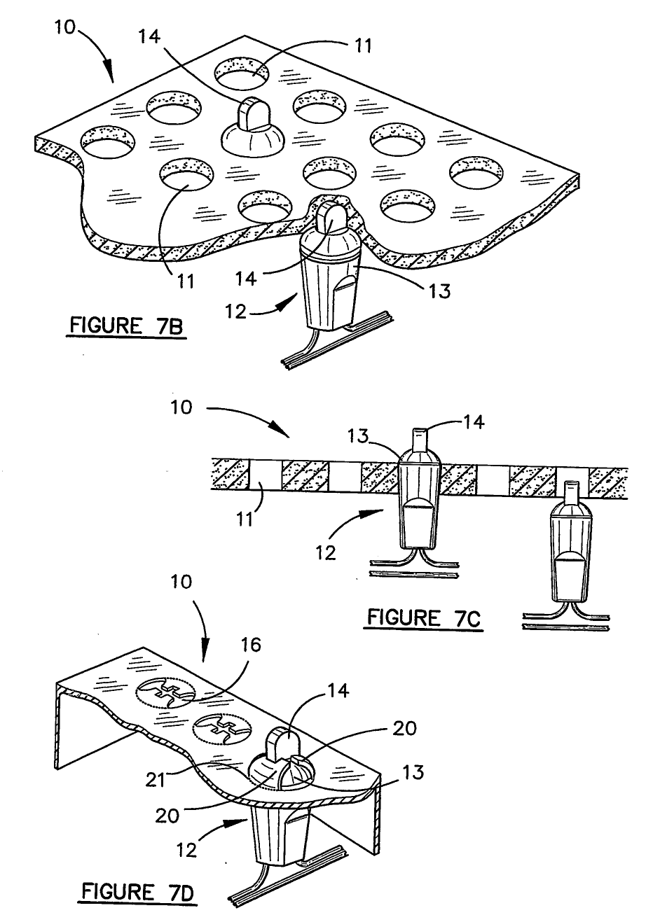

Another, simple, form of holding means is illustrated in FIGS. 7A to 7D. This holding means uses the inherent resilience of the substrate to apply a holding force on the light. In this case the substrate would be made of a material having elastic properties, such as polypropylene.

FIG. 7A shows slits 15 cut into the edges of the holes ease insertion and removal of a light 12 in the substrate. The slits 15 radiate outward from the corners of rectangular holes 11. This provides the holes with an amount of give to open up a little more as the light is inserted through. The slits 15 do not significantly alter the holding force of the substrate on the light.

FIGS. 7B and 7C illustrate a resilient substrate having an array of round holes 11 in which lights 12, and particularly LED lights, are firmly fitted. In this embodiment the substrate is a compressive foam sheet such as EVA (Ethylene Vinyl Acetate) foam or polypropylene foam. Other suitable substrate materials include polyethylene, some vinyls, compressed foam and any other material capable of compressing and recovering its shape. As shown in FIG. 7C, the diameter of each hole 11 is slightly less than the diameter of the body 13 at the top of the light where the light is to be captured by the substrate.

Accordingly, the hole 11 enlarges as the light 12 is inserted through it. When the light 12 reaches its final position with the bulb 14 protruding from the hole, the edges of the hole push against the light body 13 in an interference fit and keep it securely placed. The force in drawing the light 12 out from the hole 11 will be sufficient to overcome the interference fit and allow the light to be removed.

In FIG. 7D the slits and holes have been developed into a cut-out key hole 16. Flanges 20 in the key hole abut against the light body 13 directly under the bulb 14 to prevent the light 12 from protruding too far out of the key hole 16. The substrate material in this embodiment is more rigid than the foam-type material of figures 7B and 7C, yet still exhibits an amount of flexibility at the key hole. In this embodiment the substrate material is a rigid polypropylene sheet with die cut holes into which lights can clip into. Upon insertion of a light 12, flanges 20 bend at fold lines 21 to move outwards slightly with the light.

It is understood that where the lighting substrate is made and sold independently of the lights, modifications to the lights or clips may be required to ensure compatibility and effective connection between the two.

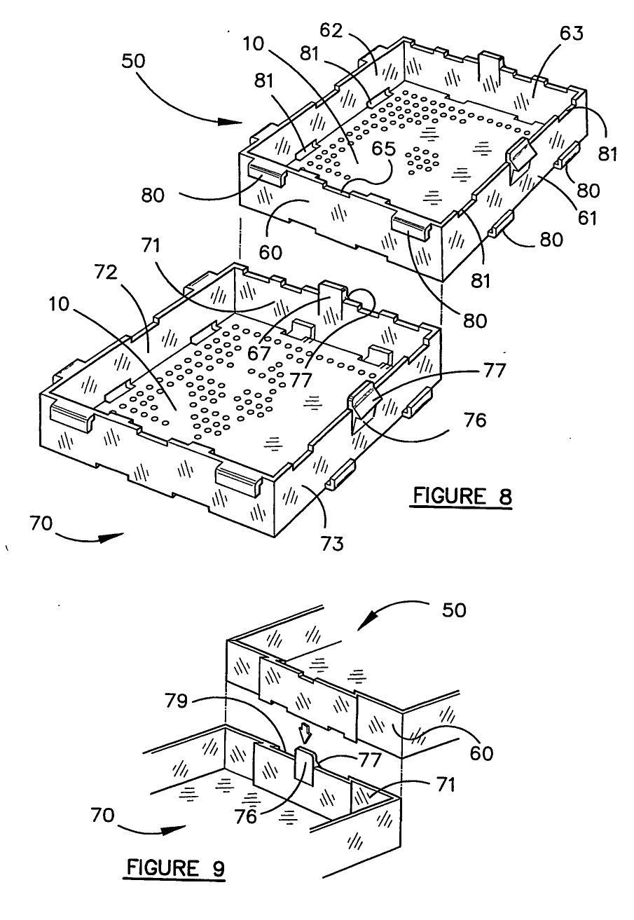

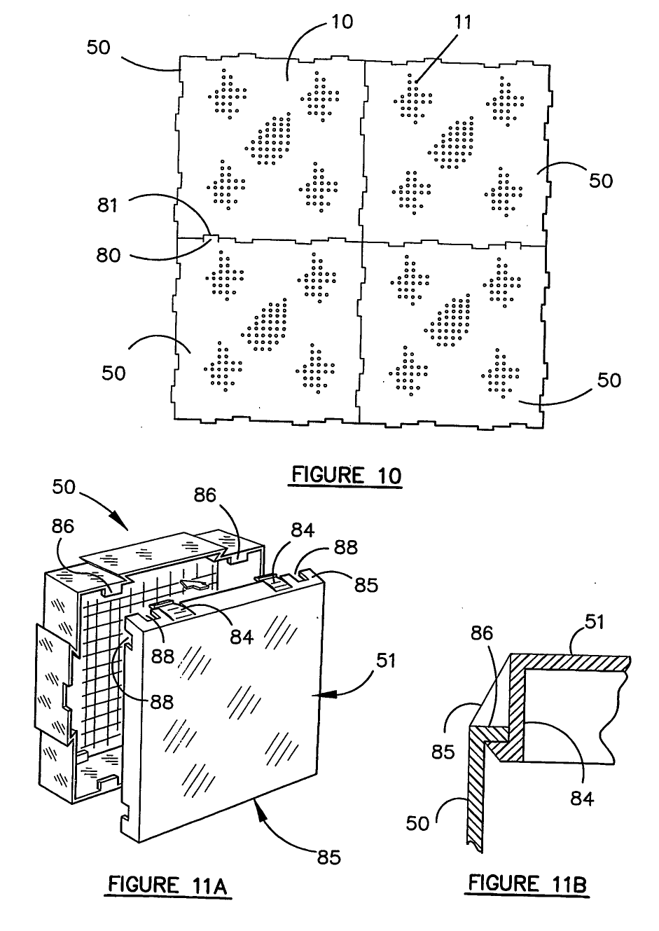

FIG. 8 shows an open casing, or panel, 50 with the bottom face of the panel defining the lighting substrate 10. Panel 50 in this embodiment is substantially square in shape with four side walls 60, 61, 62, 63 located orthogonally along the four edges of the square substrate face 10. Side walls 60, 61, 62, 63 are provided with interlocking features that allow each side wall to be interlocked with a corresponding side wall of another panel to form a larger lighting substrate matrix (as illustrated in FIG. 10. FIG. 8 illustrates part of a second panel 70 with side walls, 71, 72, 73 shown (fourth side wall is not shown).

Each side wall of panels 50, 70 is provided with either a locking tab or a locking recess, where the tab and recess interconnections of different panels may be connected to form a larger substrate matrix. Specifically, in FIG. 8 side walls 61 and 63 have tab interlocks and side walls 60 and 62 have recess interlocks. In the second panel 70 side walls 71 and 73 have tab interlocks while side walls 72 and 74 have recess interlocks.

FIG. 8 illustrates side wall 60 (recess) approaching side wall 71 (tab). The tab 76 is a resilient tab 76 cut into side wall 71. Tab 76 has a protruding tooth edge 77 that clips into recess 65, which is defined by a cut-out in side wall 60.

FIG. 8 illustrates each side wall of panels 50 and 70 having two square hooks 80 on an upper or lower edge of the wall and two corresponding hook recesses 81 on the other of the lower or upper edge of the wall. Each hook 80 is received in the corresponding hook recess 81 located at the same edge of the wall of the adjoining panel.

Accordingly, each panel has two side walls having hooks 80 located at the top edge of the wall and recesses 81 at the bottom edge of the wall, and two side walls having recesses located at the top edge and hooks at the bottom edge. In the embodiment shown in FIG. 8, two like-walls are located adjacent one another and the same like-walls also have the same interlocking feature, that is the tab or the recess interlock.

Two panels are engaged to form a larger matrix by first correctly aligning the panels such that each hook 80 on one side wall locates in a corresponding recess 81 in a side wall of the adjacent panel, and then interlocking the two panels by snap connecting tab 76 into corresponding recess 65.

In a variation illustrated in FIG. 9 square hooks 80 and hook recesses 81 are replaced with a male dove tail protrusion 66 on one side wall that interlocks with a female dove tail recess 79 in a corresponding side wall in another panel.

FIG. 9 illustrates how side wall 60 of panel 50 and side wall 71 of panel 70 slide into connection by sliding the male dovetail protrusion 66 vertically down in the direction of the arrow shown and into the female dovetail recess 79. The dovetail connection between the two panels 50, 70 prevents lateral separation. Once dovetail protrusion 66 is fully engaged in dovetail recess 79, and the substrate surfaces 10 of panels 50, 70 are flush, resilient tab 76 locks the engaged panels by snapping into recess 65. Tooth edge 77 of tab 76 prohibits the dovetail protrusion 66 and dovetail recess 79 from sliding out of engagement.

In this manner each panel can be joined on each of its four sides to another panel to create a larger matrix structure in two dimensions. FIG. 10 illustrates such a larger matrix structure where four panels have been joined together to form a larger square.

FIG. 10 is a plan view of four joined panels 50 of the type illustrated in FIG. 8 having hooks 80 and corresponding hook recesses 81. The manner of panel inter-engagement as represented in FIGS. 8 and 9 provide for the array of holes 11 in one panel to be close to the adjacent panel. Hence the spacing between holes 11 on different panels is substantially the same, or a little wider, than the hole spacing on any one panel. The closest hole to any edge of the substrate panel is within 10 mm of the edge, and preferably 5 to 7 mm of the edge. At this spacing from the edge, the holes give the larger matrix the appearance of being a single large lighting substrate.

A rear cover 51 closes off the rear of each panel. FIG. 11A illustrates a rear cover 51 attachable onto the rear of panel 50. Rear cover 51 has clips 84 on opposing side walls 85 of the rear cover 51 that clip onto a corresponding lip 86 on an upper side wall of panel 50.

FIG. 11B shows in closer view the inter-engagement of rear cover 51 and panel 50 in cross section specifically snap clip 84 fastened onto lip 86. This figure also highlights that the side walls 85 are angled outwardly to skirt around the upper circumferential edge of panel 50.

Turning back to FIG. 11A, each side wall 85 of rear cover 51 has, near the corners, a square cable hole 88 that allows electrical wiring to pass from one panel to another and back to the control circuit. Therefore, each rear cover has eight cable holes.

Instead of being formed on the cover, the cable holes may be formed in the side walls of the panel and may be any shaped aperture. There is sufficient space provided between the panel 50 and the rear cover 51 to house the wiring and electrical componentry for the lights behind the substrate.

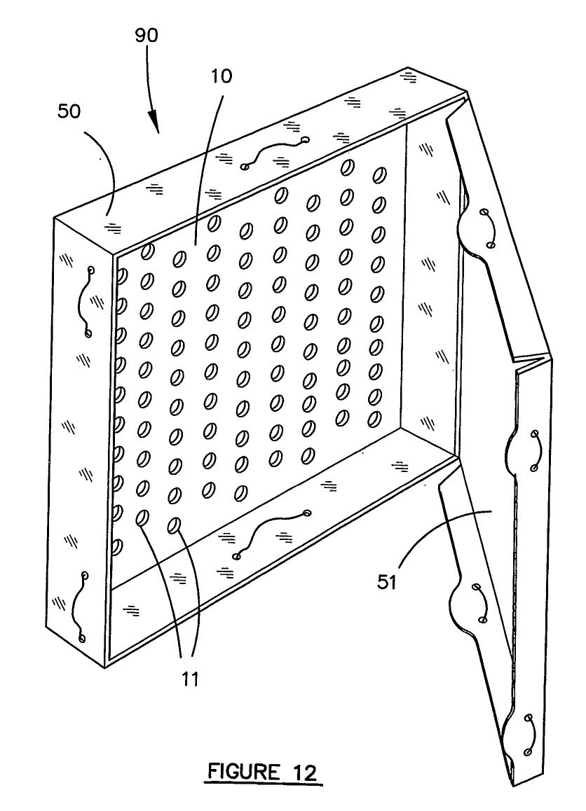

FIG. 12 illustrates another embodiment of the panel and rear cover where the rear cover 51 is hinged to the panel 50 to create a hinged box 90.

In a preferred embodiment the side lengths of the panels are between 150 mm and 250 mm, and preferably the panel dimensions are 205 mm×205 mm×40 mm. In the embodiments shown in FIGS. 1, 8 and 10 the holes are arranged in a linear matrix, that is, side by side in the same row. FIG. 12 shows an alternative arrangement of holes where the holes are aligned in an off-set matrix.

In the 205 mm×205 mm embodiment containing a linear matrix of holes, each panel contains approximately 200 to 1000 holes, depending on the size of the lights used and manufacturing constraints. Preferably there are approximately 400 holes arranged at 20 holes in each column and 20 holes in each row. This produces a high density of lights per square area of lighting substrate thereby allowing for detailed and high resolution designs and lettering to be produced. In this embodiment the density can be represented as one hole for every 1.05 cm². However, as explained above, this density may be varied depending on the size of the light globes to be used and manufacturing limitations imposed by some designs of clips. Additionally, depending on the nature of wiring and lights to be housed beneath the rear cover, the depth of the panel may be greater or less than the 40 mm described above.

All of the abovementioned panels and matrix modules may be fitted with attachment points so that they can be hung or mounted on walls, off ceilings or from any other supporting structure. The attachment point may be in the form of rectangular lugs located on the front face (the substrate face) of the panel so that the panel may be hung behind a window, or the lugs may be located on the rear cover so that the panel can be hung on a wall.

The lighting substrate and casing is adapted for use indoors and outdoors. For outdoor use water resistant substrate materials and lights ensure the lighting substrate is not damaged by weather conditions.

Using the abovementioned inter-engaging means between the panels, a larger matrix may be created in any shape including long horizontal shapes (suitable for displaying words), square and vertical panels, Tee's, “L”-shapes, hollow squares and rectangles, cross shapes, and any other shape or size as imagination and practicality will allow.

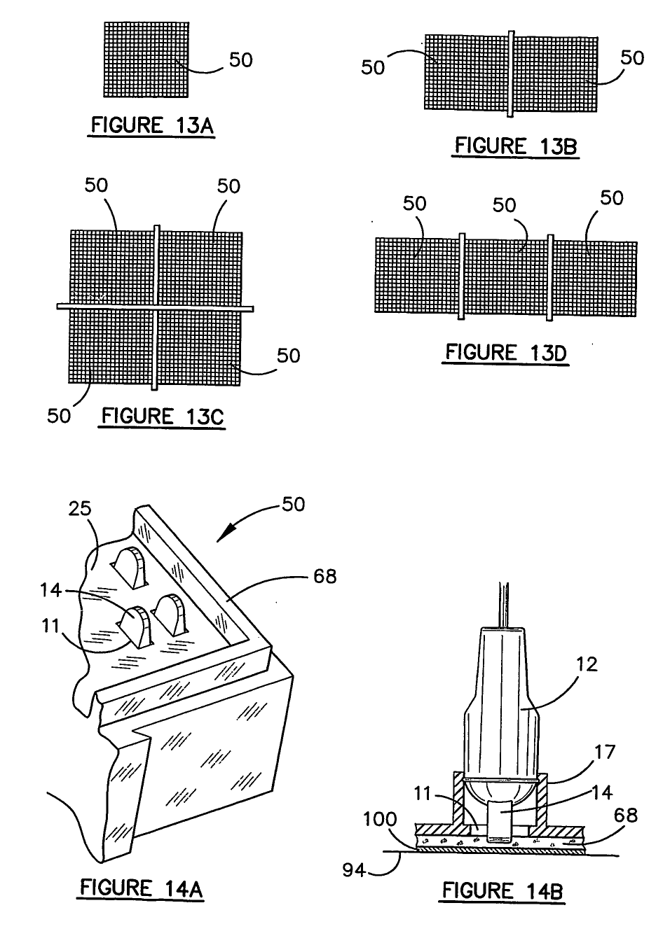

FIGS. 13A to 13D illustrate various simple forms of matrices achievable by inter-engaging two or more lighting substrate modular unit panels. FIG. 13A shows a single square panel 50. FIG. 13B shows two joined panels 50. FIG. 13C shows four panels 50 joined to form a square, and FIG. 13D illustrates three panels 50 joined in a row. It is also envisaged to form the panels from lightweight material to make it easier and safer to hang large matrices.

FIG. 14A is a part perspective view of the front substrate face 25 of the panel 50. The face also includes a raised edge 68 all around the front periphery of the face 25. Raised edge 68 extends beyond the protrusion of the light bulbs 14. This enables the assembly of the lights 12 into holes 11 to be carried out with ease by placing the panel face down and re-configuring the light arrangements on the rear of the panel. FIG. 14B shows how the raised edges 68 raise the panel off the surface 94 and protect the light bulbs 14 protruding through the holes 11 from contacting the surface 94. Accordingly, the lights can be easily and freely removed and inserted into holes 11 by way of clips 17 in any desired arrangement.

The form and colour of a substrate design or lettering may be created entirely by the user by inserting lights into selected holes. However, an added feature to the lighting substrate assists a user by providing pre-prepared designs and lettering fonts on a template.

The templates are in the form of a sheet of paper, cardboard, or the like, sized to correspond closely with the shape and size of the lighting substrate. The template is designed to be placed underneath the panel when the panel is placed face down for re-configuring the pattern of lights.

FIG. 14B illustrates a template 100 lying on the surface 94 underneath a face down panel. The template 100 contains markings corresponding to light positions, the markings forming a complete design and/or letters, words, etc. The markings are visible through holes 11 so that a user can identify into which holes lights should be inserted.

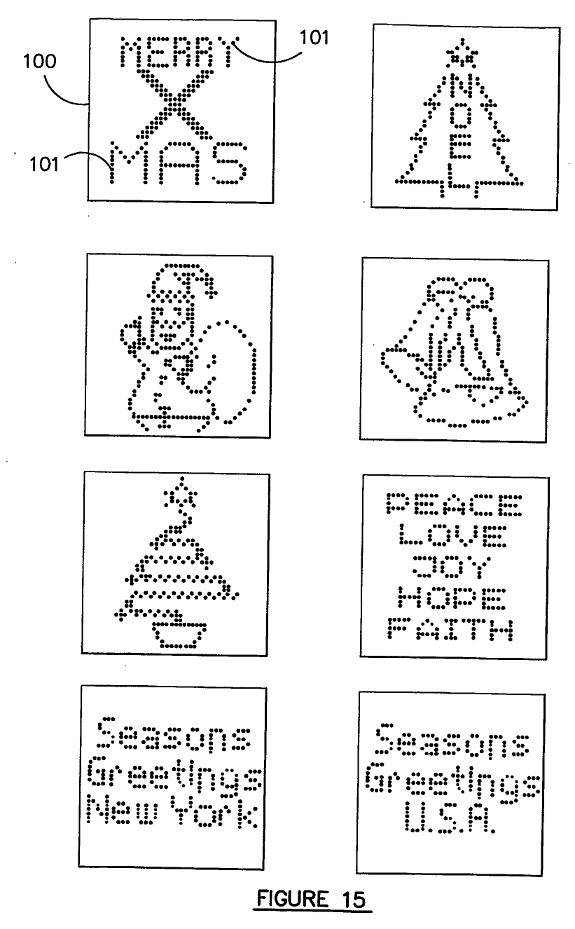

FIG. 15 illustrates eight examples of prepared templates 100. With the panel dimensions provided in the embodiment above, these examples of templates would cover an area equivalent to a four panel matrix. These illustrated designs are predominantly Christmas symbols and greetings, but it is understood that the designs may pertain to any festive occasion, personal or business message, symbol, etc.

In FIG. 15 the markings 101 are provided against a white background but another background of uniform colour, such as black, could also be used. The markings are made to be visible through the holes 11 when the panel is placed face down on the template. Accordingly, a user follows the design of the markings by inserting a light into a hole through which a marking is visible. The pre-determined shape on the template is duplicated on the lighting substrate.

Markings may additionally be colour coded to identify that certain coloured lights are to be inserted onto a hole. Where the string of lights are LED's this may mean inserting a coloured light into a hole marked by the same colour on the template underneath. With bud lights the process may be a little easier and avoid tangling of lights by inserting appropriately coloured caps into the holes and then afterwards neatly inserting a string of white lights into the caps.

Additionally, “black caps” could be located in holes where light is not wanted. The black caps are opaque so that a light inserted in the cap cannot transmit light through the cap. Further, black caps stop any light back-fill at the rear of the substrate from coming through the substrate holes to the front.

In a further embodiment of the lighting substrate, an associated software program allows a user to create a personal design on a computer, transfer that design onto a template and then use that template to recreate the personal design on a lighting substrate. The program may be loaded onto a personal computer or may be accessed through a website through which a user can access and interact with the program. The program allows the user to graphically generate and create customised messages and images and to even copy photographs such that the designs, word messages and photographic pictures can be recreated on the lighting substrate. The user is also able to select the desired text font from a wide selection of fonts.

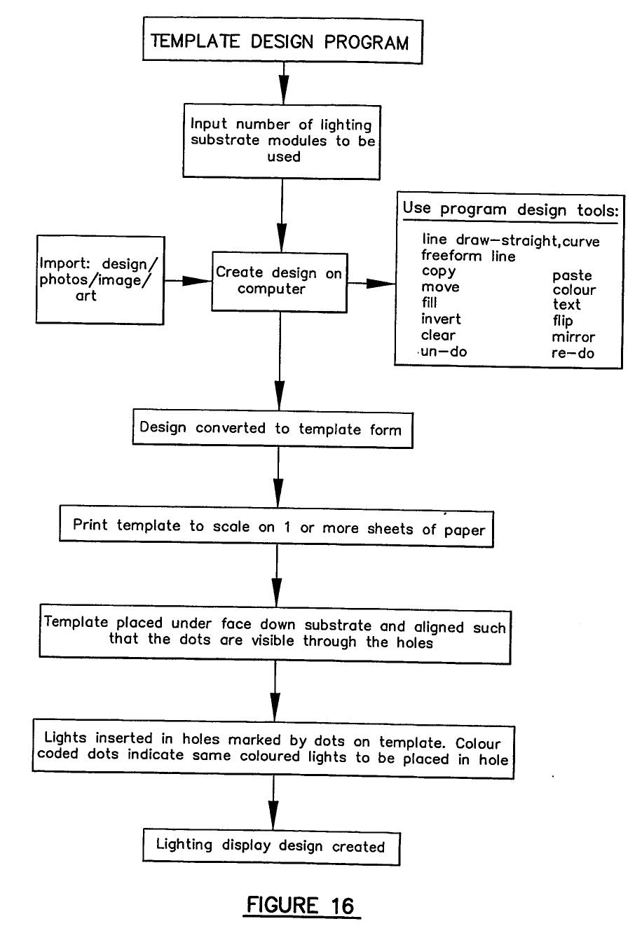

FIG. 16 is a flow chart showing the steps taken in using the template design computer program for creating a new, individual design.

The template creation program provides a variety of drawing tools to assist a user in creating a design. Such tools include a pen tool for free line drawing, straight and curved line generating tools, copy and paste facilities, colour fill, mirror, flip, move, text, un-do, re-do, invert and the like.

Before creating a design the user inputs the number of lighting substrate modular panel units to be used in the lighting display so that the design or message can be scaled to fit the number of panels. The program also selects the optimum matrix configuration (i.e. square, strip, etc.) according to the shape and style of the design. The design is then converted into an array of dots corresponding to the holes to be used in recreating the design on the lighting substrate. In this template form the design is then printed to actual size onto a sheet of paper. If the number of panels exceed the paper size, more than one sheet is printed. Generally, one sheet is printed per panel.

The customised printed template is then used in the manner described above to guide a user to load the lighting substrate panels with lights to create the customised design. The program also allows for the generation of multiple templates to be arranged side by side in sequence if a large matrix of panels is to be created.

This program provides endless opportunities for the creation of an infinite number of designs.

The base form of the present lighting substrate and additional features provides the user with a greater amount of creative freedom and expression than currently available with known lighting systems. The large number of substrate holes and the ease of reconfiguring the lights makes the substrate an inexpensive yet highly effective medium for decorating and messaging.

While two-dimensional panels have been mainly illustrated herein, the substrate could also be created three-dimensional in nature insofar as the surface of the substrate could be folded or bent into a waveform, a twisted strip, an annulus or a stepped surface. Polypropylene or foam sheets are suitable for folding and deforming for this purpose.

Other improvements and modifications falling within the spirit and scope of the invention are possible, yet are not necessarily disclosed herein but may still fall within the scope of the invention as defined by the attached claims.

1. A lighting substrate for supporting an array of interconnected lights at space intervals, the substrate including an array of holes and holding means arranged at least at some of the holes, wherein the interconnected lights are each securely but removably held in the holding means to shine light through the holes.

2. The lighting substrate claimed in claim 1 wherein the holding means are permanently formed with the lighting substrate at the holes.

3. The lighting substrate claimed in claim 2 wherein the holding means are moulded with the lighting substrate.

4. The lighting substrate claimed in claim 1 wherein the holding means are detachably connected to the substrate.

5. The lighting substrate claimed in claim 4 wherein the holding means connect to the substrate by snap connections.

6. The lighting substrate claimed in claim 1, wherein the substrate is resilient and the holding means is the resilience of the substrate holding the light in place when inserted in a hole.

7. The lighting substrate claimed in claim 6, wherein slits are provided at the edge of the holes.

8. The lighting substrate claimed in claim 1, wherein the holding means is a cylindrical or part cylindrical clip extending from the rear of the substrate to confine a light there between.

9. The lighting substrate claimed in claim 8, wherein the clip has an upper lip that is adapted to snap fit into a corresponding groove on a light.

10. The lighting substrate claimed in claim 6, wherein the resilient material is polypropylene.

11. The lighting substrate claimed in claim 1, wherein the substrate has interlocking means to join the substrate to other lighting substrates to form a larger lighting substrate structure.

12. The lighting substrate claimed in claim 1, wherein the substrate forms the front face of a panel and wherein the panel has side walls to create an open casing.

13. The lighting substrate claimed in claim 12, wherein the panel is provided with a rear cover that is hinged or completely separable.

14. The lighting substrate claimed in claim 12, wherein the panel is rectangular in shape.

15. The lighting substrate claimed in claim 12, wherein the panel has interlocking means on all side walls for joining other panels to each side wall.

16. The lighting substrate claimed in claim 15, wherein the panel is square and has four side walls, and each side wall is adapted to be interconnected to another like-panel.

17. The lighting substrate claimed in claim 15, wherein the interlocking means include inter-engaging tabs and recesses located in the side walls of the panel which are engageable by recesses and tabs in the side walls of adjoining panels.

18. The lighting substrate claimed in claim 15, wherein the interlocking means include side walls being formed with one of a dovetail protrusion or dovetail recess, and being engageable with the other of the dovetail protrusion or recess formed in the side wall of an adjoining panel.

19. The lighting substrate claimed in claim 1, wherein lugs are provided on the front of the substrate and/or on the rear of the substrate to allow the lighting substrate to be hung.

20. The lighting substrate claimed in claim 12, wherein the front face of the panel is provided with a raised edge around the periphery of the front face.

21. The lighting substrate claimed in claim 1, wherein the holding means has provisions for holding a coloured cap associated with the light for filtering coloured light.

22. The lighting substrate claimed in claim 1, wherein the holding means has provisions for holding a black cap associated with the light for preventing light from passing through the substrate.

23. The lighting substrate claimed in claim 14, wherein the substrate is a square with side lengths in the range of 150 mm to 250 mm.

24. The lighting substrate claimed in claim 23, wherein the side length of the square substrate is approximately 205 mm.

25. The lighting substrate claimed in claim 23, wherein the substrate contains approximately 400 holes.

26. The lighting substrate claimed in claim 25, wherein the holes are located no more than 10 mm from the edge of the substrate.

27. A lighting substrate system comprising a lighting substrate as claimed in claim 1, and design templates for providing a guide to creating a lighting design on the substrate.

28. The lighting substrate system claimed in claim 27, wherein the design template is a sheet substantially the same size as the lighting substrate and containing markings that, when the template is placed underneath the face down lighting substrate, are visible through the holes.

29. The lighting substrate system claimed in claim 28, wherein the markings are colour coded to represent the colour of the lights.

30. The lighting substrate system claimed in claim 27, further including a computer program for creating design templates.

31. The lighting substrate system claimed in claim 30, wherein the program is capable of converting imported images into a design template.

32. The lighting substrate system claimed in claim 30, wherein the program includes drawing tool features for creating a new template design.

33. The lighting substrate system claimed in claim 30, the program including compatibility with a printer for printing the created designed template.

34. The lighting substrate system claimed in claim 30, wherein the program is a software program or can be accessed through an interactive website.

35. A method for creating a light display including:
inserting an array of interconnected lights into an array of holes in a lighting substrate, the interconnected lights being removably held in holding means arranged at least at some of the holes and adapted to shine through the holes.

36. The method claimed in claim 35, including clipping the holding means into selected holes at the rear of the lighting substrate, then connecting the lights into the holding means.

37. The method claimed in claim 35, including joining two or more lighting substrates to form a larger display.

38. The method claimed in claim 35, including following a design template to create a design on the light display.

39. The method claimed in claim 38, including placing the design template on a surface, placing the lighting substrate with the front facing down onto the template, aligning the template and lighting substrate and following markings on the template that are visible through the holes in order to replicate the design on the template.

40. The method claimed in claim 38, including creating a new design template by using a computer program.

41. The method claimed in claim 40, including drawing, importing or modifying a design on a computer program and printing the design to scale to create a design template.

42. The method claimed in claim 40, wherein the computer program is accessed through an interactive website.

43. The method claimed in claim 35, including hanging the decorative light display from lugs provided on the lighting substrate.

44. A lighting assembly comprising an array of interconnected lights, and a lighting substrate for supporting the interconnected lights at spaced intervals, the substrate including an array of holes and holding means arranged at least at some of the holes, wherein the interconnected lights are each securely but removably held in the holding means to shine light through the holes.

45. The lighting assembly claimed in claim 44, wherein the holding means have provisions for holding caps associated with the lights.

46. The lighting assembly claimed in claim 45, wherein the caps are coloured light filters or are black light blockers.

47. The lighting assembly claimed in claim 44, further including a design template for recreating the design on the template on the lighting substrate.

48. The lighting assembly claimed in claim 47, wherein the template is a sheet substantially the same size as the substrate and containing markings that are visible through the holes when the template is placed underneath the faced down lighting substrate.

49. The lighting assembly claimed in claim 47, further comprising a computer program for creating the design template.

50. A modular lighting panel comprising a rectangular lighting substrate and four side walls arranged along each side of the substrate, the lighting substrate having an array of holes at spaced intervals and holding means arranged at least at some of the holes, wherein interconnected lights can be securely but removably held in the holding means, and the side walls each having interlocking means for joining the panel to another panel.
